(19) United States
(12) Patent Application Publication
(10) Pub. No.: US 2020/0056925 A1
(43) Pub. Date: Feb. 20, 2020

(54) METHOD FOR GAS SAFETY MANAGEMENT BY REGISTERING GAS EQUIPMENT INFORMATION IN GAS METER

(71) Applicant: Weihai Zhuocheng Gas Safety Device Co., Ltd., Weihai (CN)

(72) Inventors: Changsong YU, Weihai (CN); Junzheng LIAN, Weihai (CN); Huilai PANG, Weihai (CN)

(21) Appl. No.: 16/175,400

(22) Filed: Oct. 30, 2018

(30) Foreign Application Priority Data
Aug. 15, 2018 (CN) 201810928484.4

(51) Int. Cl. G01F 25/00

(52) U.S. Cl. CPC G01F 25/0053

(57) ABSTRACT

The present invention discloses a method for gas safety management by registering gas equipment information in a gas meter. The specific working step includes the following steps: a1: determining whether one startup is an illegal startup; a2: making safety judgment in flow increase; a3: determining that a flow rate should be lower than a sum of maximum flow rates and should not be higher than a range flow rate; and a4: Startup characteristic judgment is made for a startup process and superposition judgment is made for flow increase, in order to prevent accidents caused by leakage in the startup process and the using process.

### TECHNICAL FIELD

The present invention relates to the technical field of gas safety management, in particular to a method for gas safety management by registering gas equipment information in a gas meter.

### BACKGROUND ART

Gas safety problems have always been big problems drawing attentions of the industry. At present, most of safety solutions on the market mainly combine leakage detection and alarming and automatic cutting-off and have the serious defects of false alarm, short service life and the like. Some also adopt active safety management, but only protect factors of overvoltage, undervoltage, overflow, pipe burst and the like and may not effectively manage most of dangerous factors.

In the present invention, the following main problems are solved on the basis of intrinsic safety: 1, whether performance of a meter is normal or not; 2, whether present startup is normal startup of equipment or not; 3, whether a system normally uses gas or not; 4, whether a flow increase in a using process is normal and safe or not; and 5, whether a present gas using process is safe or not.

The present invention provides a novel product with a totally new safety concept of implementing whitelist management over a using process and safety management over a whitelist based on registering information of gas equipment in an intelligent gas meter. The whitelist includes many factors of the equipment information, a period, a flow rate, a flow, a temperature, pressure, artificial restrictions and the like. The whitelist is further divided into an automatic whitelist and an independent whitelist. The automatic whitelist is intelligently generated by the gas meter according to equipment registration information and equipment running characteristic information, and is generated to execute dynamic safety management over a system according to a built-in algorithm. For the independent whitelist, a user may set a stricter using condition and restriction parameter on the basis of the automatic whitelist. For example, a legal using time period is independently set and a maximum flow, maximum time limit and the like at a constant flow rate are independently set. Air tightness checking, meter failure checking and meter accuracy checking are combined with whitelist management to create a totally new, complete, independent and dynamic gas safety management mode and make a revolutionary advancement in safety management.

By use of an intelligent gas meter developed in the present invention, intrinsic safety management functions of temperature abnormity management, pressure abnormity management, startup abnormity management, flow abnormity management, abnormal use management and the like may be comprehensively realized, comprehensive protection of gas safety in use is further implemented and, if a gas utilization parameter is reasonably set, a burning and explosion probability may exactly be close to 0.

### SUMMARY OF THE INVENTION

### The Technical Problem to be Solved

For the shortcomings of the prior art, the present invention provides a method for gas intrinsic safety management by registering gas equipment information in a gas meter. The problem that existing gas safety management only protects factors of overvoltage, undervoltage, overflow, pipe burst and the like and may not effectively manage most of dangerous factors.

### Technical Solutions

In order to achieve the foregoing purpose, the present invention is implemented through the following technical solution: a method for gas safety management by registering gas equipment information in a gas meter includes a specific working step and a judgment step. The specific working step includes the following steps:

a1: a period of the equipment having a certain characteristic when the equipment is started up or is superposed with a piece of equipment for startup, specifically: when each piece of equipment is started up with maximum firepower, a product of the period thereof and a square root of a pressure difference is approximate to a constant, according to the characteristic, judging whether the equipment is normally started up or a leakage accident happens, namely judging whether the period is triggered by normal flow superposition or leakage;

a2: determining that a flow rate in a using process should be lower than a sum of maximum flow rates of started-up equipment and should not be higher than a range flow rate;

a3: determining that gas is being normally used if the flow rate keeps changing; and

a4: limiting the flow and gas using time to ensure gas safety in use because long-term gas use at a constant flow rate may be triggered by leakage, an equipment failure or a human error.

The judgment step includes the following steps:

b1: determining startup except the startup characteristic of the registered gas equipment as illegal startup;

b2: when the period greatly changes, judging whether an equipment superposition characteristic is met or not at first, and if NO, determining illegal use;

b3: if the second, third and fourth periods after startup change and the periods legally change in the using process, determining normal use with intervention;

b4: determining illegal use in case of a flow period beyond metering accuracy of gas metering equipment;

b5: for constant flow rate limiting of methane, limiting a total amount not to exceed 4% of a space volume of a using region; and

b6: for a gas appliance requiring a large flow, if the flow rate changes within a legal range in the using process, determining normal use and setting a constant flow rate limiting duration according to a maximum single running duration.

The following three calculation formulae are involved.

c1: it is set that an initially measured period is T1, an initially measured pressure difference is P1, a later measured period is T2, a later measured pressure difference is P2, a sectional area of a gas inlet of the equipment is S and a rotary volume body of the gas meter is V, it may be obtained T₁*\sqrt{p₁}=T₂*\sqrt{p₂} according to Δp=½|v² and

$$v = \frac{V}{S * T} ,$$

with a density change ignored. That is, for a specific gas outlet caliber, influence of a gas density is ignored, a product of a rooting value of the pressure difference and the period is approximate to a constant or a product of the pressure difference and a square of the period is approximate to a constant. When the gas equipment uses the gas with a maximum opening sectional area, the constant obtained at this moment is defined as a startup constant of the gas equipment and the constant is the startup characteristic of the equipment.

c2: it is set that the initially measured period is T1, a flow of a period t is superposed on the basis of T1 to obtain a new period T2, then the following formula is true:

$$\frac{1}{T 2} = \frac{1}{T 1} + \frac{1}{t} and t = \frac{{T}_{1} * {T}_{2}}{{T}_{1} - {T}_{2}}$$

is further derived.

c3: a deviation calculation formula: a normal startup constant is n and a startup constant after deviation is T₁*\sqrt{P₁}=m; and when the pressure is P1, a corresponding normal period should be

$$v = \frac{V}{S ⋆ T}$$

the period after deviation changes to

$${T}_{1} = \frac{m}{\sqrt{{p}_{1}}} ,$$

T corresponding to 1.2 liters and T1 corresponding to

$$T = \frac{n}{\sqrt{{p}_{1}}} ,$$

and the deviation is

$$\frac{1.2 - \frac{T 1 * 1.2}{T}}{1.2} = 1 - \frac{T 1}{T} = 1 - \frac{m}{n} = \frac{n - m}{n} * 100 \% .$$

Preferably, the method for gas safety management by registering the gas equipment information in the gas meter according to claim 1 is characterized in that the period in Step a1 refers to a time of a rotary volume.

Preferably, the method for gas safety management by registering the gas equipment information in the gas meter according to claim 1 is characterized in that the constant flow rate in Step a4 is required to be judged through the period, and when the pressure fluctuates, the constant flow rate is also required to be judged according to the product of the rooting value of the pressure difference and a period value.

Preferably, the method for gas safety management by registering the gas equipment information in the gas meter according to claim 1 is characterized in that the product of the period of each piece of equipment and the rooting value of the pressure difference is approximate to a constant when it is started up with the maximum firepower, as described in Step a1.

Preferably, the method for gas safety management by registering the gas equipment information in the gas meter according to claim 1 is characterized in that, for flow superposition described in Step a1, a superposed flow period may be calculated through a formula, it is set that the initially measured period is T1, the flow of the period t is superposed on the basis of T1 to obtain the new period T2, then the following formula is true:

$$t = \frac{T 1 * T 2}{T 1 - T 2} ,$$

and whether an equipment flow or a leakage flow is superposed may be accurately judged accordingly.

Preferably, the method for gas safety management by registering the gas equipment information in the gas meter according to claim 1 is characterized in that, for a gas metering performance problem described in Step b6, the specific deviation may be calculated through a formula, it is set that a recorded product of the equipment period and the square root of the pressure difference is n, a later obtained product of the period and the square root of the pressure difference is m, and then

$$\frac{n - m}{n} * 100 \%$$

is a metering deviation rate of the gas meter.

### Beneficial Effects

Compared with the prior art, the method provided by the present invention for gas safety management by registering the gas equipment information in the gas meter has the following beneficial effects.

1: the period characteristic in a startup process is locked, and most of sudden leakage accidents happening within a range may be judged.

2: safety analysis is performed on the superposed flow in the using process, so that leakage accidents in the gas using process may be completely eradicated.

3: the constant flow rate in the using process is analyzed, so that it may effectively be ensured that total uncontrolled gas consumption is within a safety range and burning and explosion accidents are avoided.

4: the constant flow rate in the using process is analyzed, so that safety problems brought by forgetting to turn off the heat may be avoided.

5: leakage accidents beyond the range may be completely eradicated by over-ranging management.

6: after a valve is closed, pressure drop of a cavity is analyzed and air tightness of the system may be checked, so that gas safety in use may further be ensured.

7: a meter accuracy monitoring method is adopted for the equipment and a meter failure and manmade damage may be timely found, which is essential for ensuring gas safety in use dependently on the gas meter.

8: a temperature and pressure sensor is arranged to provide assistance in temperature and pressure judgment, so that unsafe factors of an environmental temperature abnormity, a pipeline pressure abnormity and the like may be effectively controlled, and potential safety hazards may be completely eradicated.

### DETAILED DESCRIPTION OF THE INVENTION

The technical solutions in the embodiments of the present invention will be clearly and completely described below in combination with the embodiments of the present invention. It is apparent that the described embodiments are not all the embodiments but only part of embodiments of the present invention. All other embodiments obtained by those of ordinary skill in the art on the basis of the embodiments in the present invention without creative work shall fall within the scope of protection of the present invention.

The embodiments of the present invention provide a technical solution for gas use: a method for gas safety management by registering gas equipment information in a gas meter, which includes construction of an intelligent gas meter and a judgment mechanism. Construction of the intelligent diaphragm gas meter of which a rotary volume is 1.2 liters and a range is 4 m³/h includes the following steps.

In a1, a temperature and pressure sensor for determining gas pressure and a gas temperature is arranged at a gas outlet end.

In a2, a temperature and pressure sensor for determining atmospheric pressure and an environmental temperature is arranged at an outside circuit.

In a3, an electromechanical conversion device may measure the number of periods of which each is a rotary volume.

In a4, a built-in cut-off valve is configured to cut off gas supply in case of an abnormity.

In a5, general functions and judgment standards are adopted:

1) when a difference of inner and outer pressure of the meter is larger than 8,000 Pa or smaller than 400 Pa, the meter is immediately disabled;

2) when an external environmental temperature is higher than 55° C., the meter is immediately disabled;

3) when a flow exceeds a metering range, for example, for a G4 meter, T is shorter than 1.08 seconds or T is longer than 120 seconds, the meter is immediately disabled;

4) period prolonging is a necessary condition for judging that the gas is being used; and

5) it is set that a startup period of a cooker is not shorter than 9 seconds.

In a6, a general constant flow rate judgment rule: an initial period and pressure difference are recorded, and when a fluctuation of the pressure difference does not exceed 200 Pa, the period is considered only; and when the fluctuation of the pressure difference exceeds 200 Pa, real-time T*\sqrt{Δp} is compared with starting T*\sqrt{Δp} for constant flow rate judgment.

In a7, a general constant flow rate limiting condition: a flow accumulated at a constant flow rate in a period longer than 4.5 seconds is controlled according to 4% of a space volume of a region where the equipment is located, and its default value set by the equipment is 0.4 m³; and a flow accumulated at a constant flow rate in a period shorter than 4.5 seconds is controlled according to a total gas using duration which is set as a default to be 10 minutes.

A second period (set to be T) after startup is recorded and a pressure difference ΔP in the second period is recorded. The judgment mechanism includes the following steps.

If T is longer than 9 seconds:

in b1, constant flow rate judgment is made by taking a startup point as a starting point;

in b2, the constant flow rate is kept after startup: 1, when T is longer than 42 seconds and if a time limit 30 minutes is reached, the valve is closed and leakage is reported; 2, when T is between 42 seconds and 9 seconds and if a flow limit 0.4 m³ is reached, the valve is closed and overtime use or leakage is reported;

in b3, when it is monitored that the period is prolonged, it is judged that the cooker is being normally used and constant flow rate judgment is continued by taking a new point as the starting point;

in b4, when it is monitored that the period is shortened and longer than 4.5 seconds, constant flow rate judgment is continued by taking the new point as the starting point;

in b5, when it is monitored that the period is shortened and shorter than 4.5 seconds, superposition judgment is started; a superposed flow period is calculated according to a basic formula

$$t = \frac{T 1 * T 2}{T 1 - T 2} ;$$

for the superposed period, 1, if it is longer than 9 seconds, it is considered as superposition of a cooker flow, normal superposition judgment is made and constant flow rate judgment is continued; and 2, if it is shorter than 9 seconds, T*\sqrt{Δp} is calculated, whether there is a startup constant matched with this numerical value or not is checked, if YES, normal superposition is determined and constant flow rate judgment is continued, and if NO, leakage is determined and the valve is closed for further processing.

If T is shorter than 9 seconds and longer than 4.5 seconds, illegal startup is determined and leakage is reported.

If T is shorter than 4.5 seconds:

in b6, a startup constant is calculated and compared with a stored startup constant, and if the same value is not found, startup of new equipment or a leakage accident is determined and constant flow rate monitoring is started:

1) if the period is kept unchanged after startup and the flow rate is kept constant for 3 minutes, the valve is closed and abnormal use or a leakage failure is reported;

2) when it is monitored that the period is prolonged and data calculated according to T*\sqrt{Δp} is larger than the calculated startup constant, it is deduced that the equipment is normally started up, the startup constant is calibrated as a first equipment startup constant, and constant flow rate judgment is continued on the basis of the new period;

3) when it is monitored that the period is shortened, leakage is determined and the valve is closed immediately;

in b7, the startup constant is calculated and compared with the stored startup constant, and if they are the same, it is determined that the equipment is normally started up and constant flow rate monitoring is started:

1) when it is monitored that the period is shortened, superposition judgment is started, and if the superposed period calculated according to the basic calculation formula is longer than 9 seconds, cooker superposition is determined and constant flow rate monitoring is continued;

2) if the calculated superposed period is between 9 seconds and 4.5 seconds, an illegal flow is determined, the valve is closed and an alarm is given;

3) if the calculated superposed period is shorter than 4.5 seconds, T*\sqrt{Δp} is calculated, whether it is consistent with a startup constant of other equipment or not is checked, if NO, leakage is determined, the valve is closed and an alarm is given, and if YES, constant flow rate monitoring is continued;

4) when it is monitored that the period is prolonged, it is deduced that gas is being normally used, and constant flow rate monitoring is continued from a point where the period is prolonged;

in b8, if multiple pieces of equipment are registered in background, the operations for the first equipment are repeated and a second equipment startup constant, a third equipment startup constant and the like may be calibrated; and

in b9, when the equipment is determined to be illegally started up by the system, T*\sqrt{Δp} is calculated and set to be m, the startup constant n closest to m is found,

$$\frac{n - m}{n} * 100 \%$$

is calculated, when a user complains that the equipment is normally started up but is disabled, the numerical value is extracted and reported to the background as a deviation rate of a metering deviation of the meter, and when the user does not complain, the value is automatically cleared.

It is to be noted that relationship terms such as first and second in the present invention are adopted not always to require or imply existence of any such practical relationship or sequence between entities or operations but only to distinguish one entity or operation from another entity or operation. moreover, terms “include” and “contain” or any other variant thereof is intended to cover nonexclusive inclusions, thereby ensuring that a process, method, object or equipment including a series of elements not only includes those elements but also includes other elements which are not clearly listed or further includes elements intrinsic to the process, the method, the object or the equipment.

Although the embodiments of the present invention have been illustrated and described, those of ordinary skill in the art may know that various variations, modifications, replacements and transformations may be made to these embodiments without departing from the principle and spirit of the present invention. The scope of the present invention is defined by the appended claims and equivalents thereof.

1. A method for gas safety management by registering gas equipment information in a gas meter, comprising a specific working step and a judgment step and characterized in that the specific working step comprises the following steps:
a1: a period of the equipment having a certain characteristic when the equipment is started up or is superposed with a piece of equipment for startup, specifically: when each piece of equipment is started up with maximum firepower, a product of the period thereof and a square root of a pressure difference is approximate to a constant, according to the characteristic, judging whether the equipment is normally started up or a leakage accident happens, namely judging whether the period is triggered by normal flow superposition or leakage;
a2: determining that a flow rate in a using process should be lower than a sum of maximum flow rates of started-up equipment and should not be higher than a range flow rate;
a3: determining that gas is being normally used if the flow rate keeps changing;
a4: limiting the flow and gas using time to ensure gas safety in use because long-term gas use at a constant flow rate may be triggered by leakage, an equipment failure or a human error;
the judgment step comprises the following steps:
b1: determining startup except the startup characteristic of the registered gas equipment as illegal startup;
b2: when the period greatly changes, judging whether an equipment superposition characteristic is met or not at first, and if NO, determining illegal use;
b3: if the second, third and fourth periods after startup change and the periods legally change in the using process, determining normal use with intervention;
b4: determining illegal use in case of a flow period beyond metering accuracy of gas metering equipment;
b5: for constant flow rate limiting of methane, limiting a total amount not to exceed 4% of a space volume of a using region;
b6: for a gas appliance requiring a large flow, if the flow rate changes within a legal range in the using process, determining normal use and setting a constant flow rate limiting duration according to a maximum single running duration; and
b7: when a piece of equipment is started up with maximum firepower, recording a product of a period thereof and a square root of a pressure difference, and if it is found later that an obtained product of the period and the square root of the pressure difference is inconsistent with the recorded one, judging that metering performance of the gas meter has a problem.

2. The method for gas safety management by registering the gas equipment information in the gas meter according to claim 1, which is characterized in that the period in Step a1 refers to a time of a rotary volume.

3. The method for gas safety management by registering the gas equipment information in the gas meter according to claim 1, which is characterized in that the constant flow rate in Step a4 is required to be judged through the period, and when the pressure fluctuates, the constant flow rate is also required to be judged according to the product of the square root of the pressure difference and a period value.

4. The method for gas safety management by registering the gas equipment information in the gas meter according to claim 1, which is characterized in that the product of the period of each piece of equipment and the square root of the pressure difference is approximate to a constant when it is started up with the maximum firepower, as described in Step a1.

5. The method for gas safety management by registering the gas equipment information in the gas meter according to claim 1, which is characterized in that, for flow superposition described in Step a1, a superposed period may be calculated through a formula, it is set that the initially measured period is T1, the flow of the period t is superposed on the basis of T1 to obtain the new period T2, then the following formula is true:
$$t = \frac{T 1 * T 2}{T 1 - T 2} ,$$
and whether an equipment flow or a leakage flow is superposed may be accurately judged accordingly.

6. The method for gas safety management by registering the gas equipment information in the gas meter according to claim 1, which is characterized in that, for a gas metering performance problem described in Step b6, the specific deviation may be calculated through a formula, it is set that a recorded product of the equipment period and the square root of the pressure difference is n, a later obtained product of the period and the square root of the pressure difference is m, and then
$$\frac{n - m}{n} * 100 \%$$
is a metering deviation rate of the gas meter.
